(19) United States
(12) Patent Application Publication
(10) Pub. No.: US 2020/0020351 A1
(43) Pub. Date: Jan. 16, 2020

(54) SYSTEM AND METHOD FOR INDEXING SOUND FRAGMENTS CONTAINING SPEECH

(71) Applicant: John Rankin, Morgantown, WV (US)

(72) Inventor: John Rankin, Morgantown, WV (US)

(21) Appl. No.: 16/507,828

(22) Filed: Jul. 10, 2019

Related U.S. Application Data
(60) Provisional application No. 62/696,152, filed on Jul. 10, 2018.

(51) Int. Cl. G10L 25/51; G10L 25/18

(52) U.S. Cl. CPC G10L 25/51; G10L 25/18

(57) ABSTRACT

A system and method determining a match between sound fragments is provided. Each wave that makes up a sequence within the fragment is identified. An average amplitude and frequency of each wave is determined. An index of amplitudes and frequencies is determined by summating the square of the difference between the amplitude and frequencies, respectively, of each wave and the average amplitude and frequency, respectively, of the sequence. A single index is determined by averaging the index of amplitudes and frequencies. Matches between sound fragments may be determined by comparing the various indexes.

### CROSS-REFERENCE TO RELATED APPLICATIONS

This application claims the benefit of U.S. provisional application Ser. No. 62/696,152 filed Jul. 10, 2018, the disclosures of which are hereby incorporated by reference as if fully restated.

### TECHNICAL FIELD

Exemplary embodiments of the present invention relate generally to a system and method of indexing sound fragments containing speech, preferably based on frequency and amplitude measurements.

### BACKGROUND AND BRIEF SUMMARY OF THE INVENTION

The human ear is generally capable of detecting sound frequencies within the range of approximately 20 Hz to 20 kHz. Sound waves are changes in air pressure occurring at frequencies in the audible range. The normal variation in air pressure associated with a softly played musical instrument is near 0.002 Pa. However, the human ear is capable of detecting small variations in air pressure as small as 0.00002 Pa, and air pressure that produces pain in the ear may begin near or above 20 Pa.

Air pressure is sometimes measured in units of Pascals (Pa). A unit of Pascal is a unit of force, or Newton, per square meter. It is this change in air pressure which is detected by the human ear and is perceived as sound. The atmosphere of the planet produces an amount of pressure upon the air, and the ear, which functions as a baseline by producing a uniform amount of pressure. Generally, an atmosphere of one is considered the normal amount of pressure present on the Earth's surface and equates to about 14.7 lbs per square inch, or approximately 100,000 Pa. While this pressure can change, it has very little effect upon the movement or quality of sound. The speed of sound varies only slightly with a change in atmospheric pressure: at two atmospheres and −100° C. the speed decreases by approximately 0.013%; while at two atmospheres and 80° C. the speed increases by approximately 0.04%, for example.

Sound waves produced by human speech are complex longitudinal waves. In a longitudinal wave, the points of the medium that form the wave move in the same direction as the wave's propagation. Once a sound wave has been produced, it travels in a forward direction through a medium, such as air, until it strikes an obstacle or other medium that reflects, refracts, or otherwise interferes with the wave's propagation. The wave propagates in a repetitive pattern that has a reoccurring cycle. This cycle reoccurs as the sound wave moves and is preserved until it reaches an interacting object or medium, like the ear. This cycle oscillates at a frequency that can be measured. One unit of frequency is known as hertz (Hz), which is 1 cycle per second, and is named after Heinrich Hertz.

Complex longitudinal sound waves can be described over time by their amplitude, sometimes measured in Pascals (Pa), and frequency, sometimes measured in Hertz (Hz). Amplitude results in a change in loudness, and the human ear can generally detect pressure changes from approximately 0.0002 Pa to 20 Pa, where pain occurs. Frequency results in a change in pitch, and the human ear can generally detect frequencies between approximately 20 Hz to 20 kHz. Since the complex waves are a combination of other complex waves, a single sample of sound will generally contain a wide range of changes in tone and timbre, and sound patterns such as speech.

Therefore, what is needed is a system and method for indexing sound fragments containing speech. What is disclosed is a system and method for indexing sound fragments containing speech.

Digital representations of sound patterns containing speech may be sampled at a rate of 44 kHz and capture amplitudes with a 16-bit representation or an amplitude range of −32,768 through 32,768. In this way, the full range of human hearing may be well represented and may distinguish amplitude and frequency changes in the same general values as the human ear.

Captured speech containing a morpheme may be digitally represented by a single fragment of sound that is less than a second in duration. Each fragment may contain no more than 44,100 samples, representing the amplitude of the sound wave at each point within 1/44,100th of a second of time. The amplitude, as it is recorded, may be represented as a 16-bit number, or rather a value of 0 through 65,536.

A unique index which identifies a sound fragment that contains a part of speech may be produced. The unique characteristic of the index may provide an identification for the pattern of the sound. This may allow matching for different sound fragments that differ in amplitude or pitch. Therefore, the generated index may be unique to the pattern of the speech of an individual, but not tied to differences produced by loudness or frequency.

Further features and advantages of the systems and methods disclosed herein, as well as the structure and operation of various aspects of the present disclosure, are described in detail below with reference to the accompanying figures.

### BRIEF DESCRIPTION OF THE SEVERAL VIEWS OF THE DRAWINGS

Novel features and advantages of the present invention, in addition to those mentioned above, will become apparent to those skilled in the art from a reading of the following detailed description in conjunction with the accompanying drawings wherein identical reference characters refer to identical parts and in which:

FIG. 1 is a visual representation of a sound wave with associated amplitude measurements;

FIG. 2 is a visual representation of a sound wave with associated frequency measurements;

FIG. 3 is a simplified block diagram with exemplary logic for analyzing a sound wave; and

FIG. 4 is a simplified block diagram with exemplary logic for comparing sound waves.

### DETAILED DESCRIPTION OF THE EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Embodiments of the invention are described herein with reference to illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

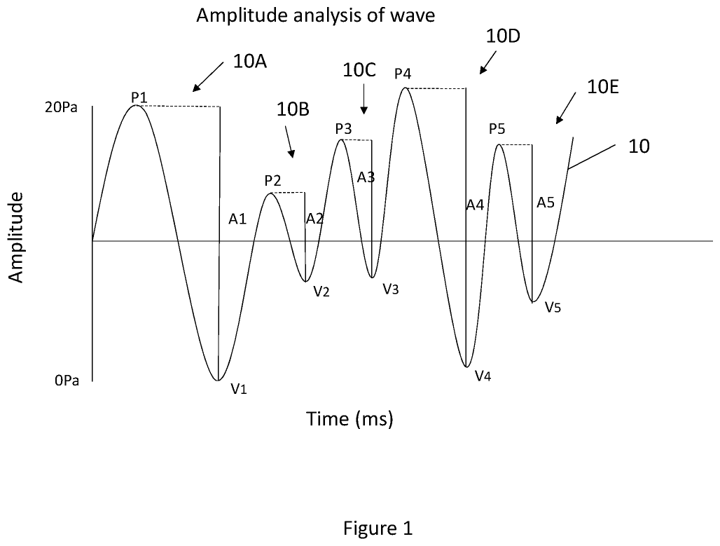

FIG. 1 is a visual representation of a sound wave 10 with associated amplitude measurements A1, A2, etc. The amplitude measurements A1, A2, etc. may reflect the gain or loss between the measured amplitude of the peaks P1, P2, etc. and the measured amplitude of the subsequent valleys V1, V2, etc. of the sound wave 10. An absolute value of the peaks P1, P2, etc., valleys V1, V2, etc., and/or amplitude measurements A1, A2, etc. may be taken as required. The amplitude measurements A1, A2, etc. may be measured in pascals, though any unit of measurement is contemplated. The sound wave 10 may be plotted along a timeline, which may be measured in milliseconds, though any unit of measure is contemplated. Illustrated sound wave 10 is merely exemplary and is not intended to be limiting.

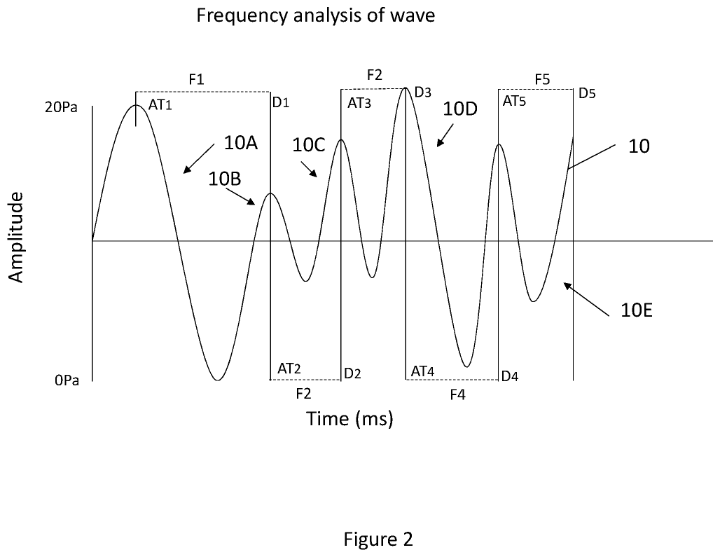

FIG. 2 is a visual representation of the sound wave 10 with associated frequency measurements F1, F2, etc. The frequency measurements F1, F2, etc. may reflect the time between peaks P1, P2, etc. of the sound wave 10. More specifically, the initial peak (e.g., P1) may be referred to as an attack AT1, AT2, etc. and the following peak (e.g., P2) may be referred to as a decline D1, D2, etc. Alternatively, or in addition, the frequency measurements F1, F2, etc. may be taken to determine the time between valleys V1, V2, etc. of the sound wave 10, such that the initial valley (e.g., V1) may be referred to as the attack AT1, AT2, etc. and the following valley (e.g., V2) may be referred to as the decline D1, D2, etc. The sound wave 10 may be plotted along a timeline, which may be measured in milliseconds, though any unit of measure is contemplated. The frequency may be measured in cycles per second (Hz), though any unit of measure is contemplated. Illustrated sound wave 10 is merely exemplary and is not intended to be limiting.

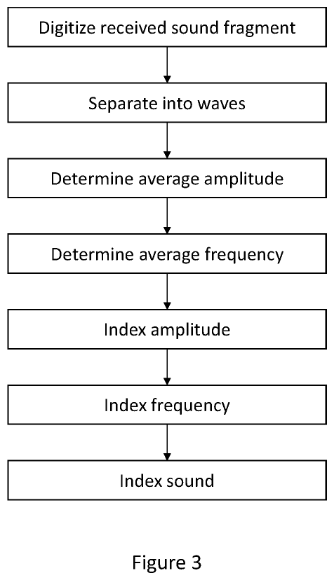

FIG. 3 is a simplified block diagram with exemplary logic for analyzing the sound wave 10. A recorded fragment of sound that contains part of human speech may be received and digitized into a representation of the sound wave 10. The recorded fragment may be produced by another process and converted to a standard form. The digital image may be sampled at a frequency rate of 44.1 kHz, though any rate is contemplated. Each sample point may comprise a 16-bit number that represents the amplitude of the sound wave 10 at the sampled moment in time, though any representation is contemplated. The amplitude may be provided in units of pascals, though any unit of measure is contemplated. A word, phrase, partial, or whole sentence, or a series of words phrases, partial or whole sentences may define a sequence within one or more fragments, where each sequence may comprise one or more waves 10A, 10B, etc.

The digital fragment representation of the sound wave 10 may be examined to determine each distinctive wave 10A, 10B, etc. contained within the complex sound segment 10. An average amplitude of the entire fragment may be calculated. The average amplitude may be determined by use of formula 1, though such is not required. Each wave 10A, 10B, etc. within the overall fragment 10 may be measured to determine the difference between the peak (Pᵢ) and the valley (Vᵢ) of each wave and arrive at the amplitude (Aᵢ).

$$Formula 1$$

$$Calculation for Average Amplitude$$

$$\text{Average Amplitude (} \text{AvA} \text{)} = \frac{{\sum }_{a = 1}^{n} ( P a - Va )}{n}$$

An average frequency of the entire fragment may be calculated. The average frequency may be determined by use of formula 2, though such is not required. Each wave 10A, 10B, etc. within the overall fragment 10 may be measured to determine the length of time between the attack (ATᵢ) and the decay (Dᵢ) to determine the frequency (Fᵢ) of each wave.

$$Formula 2$$

$$Calculation for Average Frequency$$

$$Average Frequency ( AvF ) = \frac{{\sum }_{b = 1}^{n} ( Db - ATb )}{n}$$

An index of the sound fragment's 10 amplitude A1, A2, etc. may be produced by calculating the summation of the square of the difference between the amplitude A1, A2, etc. of each wave 10A, 10B, etc. and the average of the overall wave 10, as defined in formula 3, though such is not required. An index may be created from these calculations which uniquely identifies the pattern of the amplitude A1, A2, etc., rather than the exact image of the amplitude A1, A2, etc. This index may match other sound fragments 10 that contain an equivalent pattern of amplitude A1, A2, etc. change, even when the individual amplitudes A1, A2, etc. are different.

Index Amplitude (IdxA)=Σᵢ₌₁ⁿ((AvA)−(Pi−Vi))² Formula 3: Index Calculation for Amplitude

An index of the sound fragment's 10 frequency F1, F2, etc. may be produced by calculating the summation of the square of the difference between the frequency F1, F2, etc. of each wave 10 and the average of the overall wave, as defined in formula 4, though such is not required. An index may be created from these calculations which uniquely identifies the pattern of the frequency F1, F2, etc., rather than the exact image of the individual frequency F1, F2, etc.

Index Frequency (IdxF)=Σᵢ₌₁ⁿ((AvF)−(Di−ATi))² Formula 4: Index Calculation for Frequency

A single sound fragment index may be produced by averaging the amplitude index and the frequency index, as defined in formula 5, though such is not required. This index may be used to uniquely and quickly identify the sound fragment 10 by the pattern of its amplitude A1, A2, etc. and frequency F1, F2, etc.

$$Formula 5$$

$$Index Calculation for Sound Fragment$$

$$\text{Index Sound (Index)} = \sqrt{\frac{IdxA + IdxF}{2}}$$

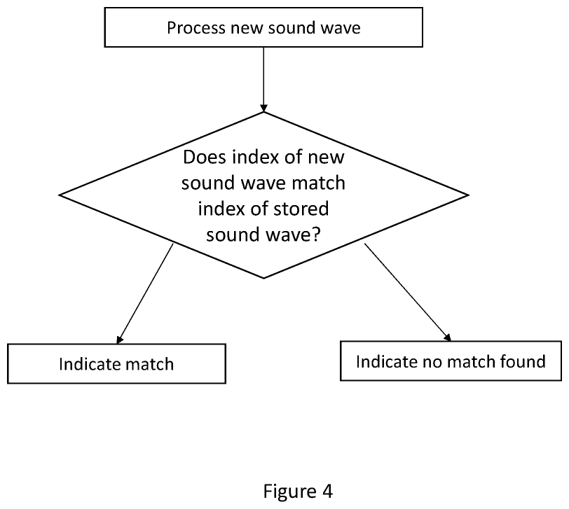

FIG. 4 is a simplified block diagram with exemplary logic for comparing sound waves 10. The three indexes described herein may be used to tag sound fragments 10 in a way that uniquely identify the patterns contained in such fragments. By indexing a number of sound waves 10 in this way, it is possible to quickly match newly collected sound fragments against the indexed fragments by comparing the patterns of the newly collected fragments 10 against the indexed fragments. Since there are three separate indexes, it is possible to distinguish between a sound fragment that matches the pattern of amplitude versus frequency. A margin of error may be utilized when comparing the various indexes described herein.

Each of the collected and indexed fragments may be used to build a database. Each of the collected and indexed fragments may be associated with identifying information for the speaker of the given fragment. New fragments may be received, digitized, the various indexes described herein may be determined. The indexes of the newly received fragment may be compared against the indexes of those in the database to determine a match.

Any embodiment of the present invention may include any of the optional or exemplary features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

Certain operations described herein may be performed by one or more electronic devices. Each electronic device may comprise one or more processors, electronic storage devices, executable software instructions, and the like configured to perform the operations described herein. The electronic devices may be general purpose computers of specialized computing device. The electronic devices may be personal computers, smartphone, tablets, databases, servers, or the like. The electronic connections described herein may be accomplished by wired or wireless means.

What is claimed is:

1. A method for determining a match between sound fragments comprising the steps of:
identifying each wave that makes up a first sequence within a first sound fragment and each wave that makes up a second sequence within a second sound fragment;
determining an average amplitude of each wave within the first sequence of waves;
determining an average amplitude of each wave within the second sequence of waves;
determining an average frequency of each wave within the first sequence of waves;
determining an average frequency of each wave within the second sequence of waves; and
comparing the average amplitude and frequency of the first sequence with the average amplitude and frequency of the second sequence to determine a match.

2. The method of claim 1 further comprising the steps of:
calculating a first index of frequencies by summating the square of the difference between the frequency of each wave of the first sequence and the average frequency of the first sequence; and
calculating a second index of frequencies by summating the square of the difference between the frequency of each wave of the second sequence and the average frequency of the second sequence.

3. The method of claim 2 further comprising the steps of:
comparing the first index of frequencies with the second index of frequencies to determine a match.

4. The method of claim 1 further comprising the steps of:
calculating a first index of amplitudes by summating the square of the difference between the amplitude of each wave of the first sequence and the average amplitude of the first sequence; and
calculating a second index of amplitudes by summating the square of the difference between the amplitude of each wave of the second sequence and the average amplitude of the first sequence.

5. The method of claim 4 further comprising the steps of:
comparing the first index of amplitudes with the second index of amplitudes to determine a match.

6. The method of claim 3 further comprising the steps of:
calculating a first index of amplitudes by summating the square of the difference between the amplitude of each wave of the first sequence and the average amplitude of the first sequence;
calculating a second index of amplitudes by summating the square of the difference between the amplitude of each wave of the second sequence and the average amplitude of the first sequence; and
comparing the first index of amplitudes with the second index of amplitudes to determine a match.

7. The method of claim 6 further comprising the steps of:
averaging the first index of amplitude and the first index of frequencies to produce a first single index;
averaging the second index of amplitude and the second index of frequencies to produce a second single index; and
comparing the first single index with the second single index to determine a match.

8. The method of claim 4 further comprising the steps of:
averaging the first index of amplitude and the first index of frequencies to produce a first single index;
averaging the second index of amplitude and the second index of frequencies to produce a second single index; and
comparing the first single index with the second single index to determine a match.

9. The method of claim 1 wherein:
the amplitude of each wave is measured in pascals.

10. The method of claim 1 wherein:
the frequency is measured by determining the distance between peaks of each wave within the sequence.

11. The method of claim 1 further comprising the steps of:
receiving a sound fragment; and
digitizing the sound fragment.

12. A system for determining a match between sound fragments comprising:
providing a non-transitory computer readable medium comprising software instructions, which when executed by a processor, configure the processor to:
identify each wave that makes up a first sequence within a first sound fragment and a second sequence within a second sound fragment;
determine an average amplitude of each wave within the first and second sequences of waves;
determine an average frequency of each wave within the first and second sequences of waves;
compare the average amplitude and frequency of the first sequence with the average amplitude and frequency of the second sequence to determine a match.

13. The system of claim 12 wherein:
the non-transitory computer readable medium comprises additional software instructions, which when executed by the processor, configure the processor to calculate an index of frequencies for the first and second sequence by summating the square of the difference between the frequency of each wave and the average frequency of each respective sequence of waves.

14. The system of claim 13 wherein:
the non-transitory computer readable medium comprises additional software instructions, which when executed by the processor, configure the processor to calculate an index of amplitudes for the first and second sequence by summating the square of the difference between the amplitude of each wave and the average amplitude of each respective sequence of waves.

15. The system of claim 14 wherein:
the non-transitory computer readable medium comprises additional software instructions, which when executed by the processor, configure the processor to average the index of amplitudes and the index of frequencies for the first and second sequence to produce a single index for each respective sequence of waves.

16. The system of claim 15 wherein:
the non-transitory computer readable medium comprises additional software instructions, which when executed by the processor, configure the processor to compare the single index of the first sequence of waves with the index of the second sequence of waves to determine a match.

17. A method for determining a match between sound fragments comprising the steps of:
generating a database of indexed sound fragments by, for each of a plurality of received sound fragments as well as a at least one newly received sound fragment:
identifying each wave that makes up a sequence within the respective sound fragment;
determining an average amplitude of each wave within the respective sequence of waves;
determining an average frequency of each wave within the respective sequence of waves;
calculating an index of amplitudes, by summating the square of the difference between the amplitude of each wave and the average amplitude of the respective sequence of waves;
calculating an index of frequencies, by summating the square of the difference between the frequency of each wave and the average frequency of the respective sequence of waves; and
averaging the index of amplitudes and the index of frequencies index to produce a single index for the respective sequence of waves; and
comparing the single index of at least one newly received sound fragment with the single index of each of the plurality of received sound fragments within the database to determine the presence or non-presence of a match.

18. The method of claim 17 wherein:
a match is determined where the single index of the at least one newly received sound fragment is within a margin of error of one or more of the plurality of received sound fragments within the database.

19. The method of claim 17 wherein:
no match is determined where the single index of the at least one newly received sound fragment is not within a margin of error of any of the plurality of received sound fragments within the database.

20. The method of claim 17 further comprising the steps of:
storing, at the database, the single index of the at least one newly received sound fragment.
